(19) United States
(12) Patent Application Publication
(10) Pub. No.: US 2010/0011045 A1
(43) Pub. Date: Jan. 14, 2010

(54) Device and method for applying signal weights to signals

(76) Inventor: James Vannucci, McDonald, PA (US)

Correspondence Address: James Vannucci, 5212 Forest View Drive, McDonald, PA, 15057, US

(21) Appl. No.: 12/454,679

(22) Filed: May 22, 2009

Related U.S. Application Data
(63) Continuation-in-part of application No. 12/453,092, filed on Apr. 29, 2009.
Application No. 12/453,092 is a continuation-in-part of application No. 12/453,078, filed on Apr. 29, 2009.
Application No. 12/453,078 is a continuation-in-part of application No. 12/218,052, filed on Jul. 11, 2008.

(51) Int. Cl. G06F 17/14; G06F 7/32

(52) U.S. Cl. 708/404; 708/400; 708/520

(57) ABSTRACT

Signal weights corresponding to an initial system of equations with a block coefficient matrix T₀ can be obtained from the solution to a system of equations with a block coefficient matrix T. The matrix T is approximately equal to the matrix T₀. The signal weights can be used to generate a desired signal.

### CROSS-REFERENCE TO RELATED APPLICATIONS

This application is a Continuation in Part of U.S. Ser. No. 12/453,092, filed on Apr. 29, 2009, which is a Continuation in Part of U.S. Ser. No. 12/218,052, filed on Jul. 11, 2008, and a Continuation in Part of U.S. Ser. No. 12/453,078 filed on Apr. 29, 2009, all of which are incorporated herein.

### STATEMENT REGARDING FEDERALLY SPONSORED RESEARCH OR DEVELOPMENT

Not applicable.

### REFERENCE TO A COMPUTER PROGRAM LISTING COMPACT DISC APPENDIX

Not applicable.

### BACKGROUND OF THE INVENTION

The present invention concerns a device and methods for determining and applying signal weights to known signals. Many devices, including imaging, sensing, communications and general signal processing devices calculate and apply signal weights to known signals for their operation. The disclosed device can be a component in these signal processing devices.

Communications devices typically input, process and output signals that represent data, speech or image information. The devices can be used for communications channel estimation, mitigating intersymbol interference, cancellation of echo and noise, channel equalization, and user detection. The devices usually use digital forms of the input signals to generate a covariance matrix and a crosscorrelation vector for a system of equations that must be solved to determine the signal weights. The signal weights must be applied to known signals for the operation of the device. The covariance matrix may be block Toeplitz, or approximately block Toeplitz. The performance of a communications device is usually directly related to the maximum dimensions of the system of equations, and the speed with which the system of equations can be solved. The larger the dimensions of the system of equations, the more information can be contained in the weight vector. The faster the system of equations can be solved, the greater the possible capacity of the device.

Sensing devices, including radar, ladar and sonar systems, require calculating and applying a signal weight vector to a known signal for their operation. The signal weights are determined from the solution of a system of equations with a complex, approximately block Toeplitz coefficient matrix if the sensor array is two dimensional, and has equally spaced elements. The performance of the sensing device is usually related to the maximum dimensions of the system of equations, since this usually determines the resolution of the device. The performance of the sensing device also depends on the speed at which the system of equations can be solved. Increasing the solution speed can improve tracking of the target, or determining the position of the target in real time. Larger sensor arrays also result in a much narrower beam for resistance to unwanted signals.

Imaging devices, including medical imaging devices such as magnetic resonance imaging MRI, computed tomography CT and ultrasound devices, require calculating signal weights to form an image. The signal weights are determined from the solution of a system of equations with a block Toeplitz coefficient matrix. The performance of the imaging device is usually related to the maximum dimensions of the system of equations, since this usually determines the resolution of the device. Device performance is also improved by increasing the speed at which the system of equations can be solved.

General signal processing devices include devices for control of mechanical, biological, chemical and electrical components, and devices that include digital filters. These devices typically process signals that represent a wide range of physical quantities. The signals are used to generate a block Toeplitz covariance matrix and a known vector in a system of equations that must be solved for signal weights required for the operation of the device. The performance of the device is usually directly related to the maximum dimensions of the system of equations, and the speed at which the system of equations can be solved.

Signal weights in the above devices are determined by solving a system of equations with a block Toeplitz coefficient matrix. The prior art solution methods for a system of equations with a block Toeplitz coefficient matrix include iterative methods and direct methods . Iterative methods include methods from the conjugate gradient family of methods. Direct methods include Gauss elimination, and decomposition methods including Cholesky, LDU, eigenvalue, singular value, and QR decomposition can also be used to obtain a solution in O(n³) flops.

The following devices require the solution of a system of equations with a block Toeplitz, or approximately block Toeplitz, coefficient matrix for their operation. Sensing devices including radar, ladar and sonar devices as disclosed in Zrnic (U.S. Pat. No. 6,448,923), Barnard (U.S. Pat. No. 6,545,639), Davis (U.S. Pat. No. 6,091,361), Pillai (2006/0114148), Yu (U.S. Pat. No. 6,567,034), Vasilis (U.S. Pat. No. 6,044,336), Garren (U.S. Pat. No. 6,646,593), Dzakula (U.S. Pat. No. 6,438,204), Sitton et al. (U.S. Pat. No. 6,038,197) and Davis et al. (2006/0020401). Communications devices including echo cancellers, equalizers and devices for channel estimation, carrier frequency correction, mitigating intersymbol interference, and user detection as disclosed in Kung et al. (2003/0048861), Wu et al. (2007/0133814), Vollmer et al. (U.S. Pat. No. 6,064,689), Kim et al. (2004/0141480), Misra et al. (2005/0281214), Shamsunder (2006/0018398), and Reznik et al. (2006/0034398). Imaging devices including MRI, CT, PET and ultrasound devices as disclosed in Johnson et al. (U.S. Pat. No. 6,005,916), Chang et al. (2008/0107319), Zakhor et al. (U.S. Pat. No. 4,982,162) and Liu (U.S. Pat. No. 6,043,652). General signal processing devices including noise and vibration controllers as disclosed in Preuss (U.S. Pat. No. 6,487,524), antenna beam forming systems as disclosed in Wu et al. (2006/0040706) and Kim et al. (2005/0271016), and image restorers as disclosed in Trimeche et al. (2006/0013479).

The prior art discloses decomposition and iterative methods that are used to solve systems of equations in the above-indicated devices. These methods are computationally very slow, and many are unreliable when applied to ill conditioned coefficient matrices. These methods often require that the coefficient matrix be regularized. When these methods are implemented on the above-mentioned devices, the devices have large power requirements, and produce a large amount of heat.

The disclosed device and methods solve a system of equations with a block Toeplitz coefficient matrix with far fewer flops. Systems of equations with larger dimensions can also be solved by the disclosed methods than by the prior art methods. Regularization is usually not required with the disclosed methods because the coefficient matrix is altered in a manner that reduces the condition number of the coefficient matrix. The disclosed methods can process ill conditioned coefficient matrices since the altered coefficient matrix has an improved condition number. The power consumption, and heat dissipation, requirements of the device are reduced as a result of the large decrease in processing steps required by the disclosed methods.

### BRIEF SUMMARY OF THE INVENTION

Many devices determine and apply signal weights for their operation. The signal weights can be calculated by solving a system of equations with a block Toeplitz coefficient matrix. This solution can be obtained with increased efficiency if the dimensions of the sub-blocks of the coefficient matrix and the system of equations are reduced. After the dimensions of the systems of equations are reduced, any methods known in the art can be used to obtain the solution to the systems of equations with reduced dimensions.

The solution to the system of equations with a block Toeplitz coefficient matrix can also be obtained with increased efficiency if the sub-blocks of the block Toeplitz coefficient matrix are individually altered by increasing their dimensions, modified by adding rows and columns, approximated, and then transformed. The transformed sub-blocks have a narrow banded form. The rows and columns of the system of equations are then rearranged to obtain a coefficient matrix with a single narrow band. The system of equations with the single narrow banded coefficient matrix is then solved. The solution to the original system of equations is then obtained from this solution by iterative methods. Additional unknowns are introduced into the system of equations when the dimensions of the system of equations are increased, and when the sub-blocks are modified. These unknowns can be determined by a number of different methods.

Devices that require the solution of a system of equations with a block Toeplitz, or approximately block Toeplitz, coefficient matrix can use the disclosed methods, and achieve very significant increases in performance. The disclosed methods have parameters that can be selected to give the optimum implementation of the methods. The values of these parameters are selected depending on the particular device in which the methods are implemented.

### DRAWINGS

FIG. 1 shows the disclosed device as a component in a signal processing device.

FIG. 2 shows the components of the disclosed device.

### DETAILED DESCRIPTION

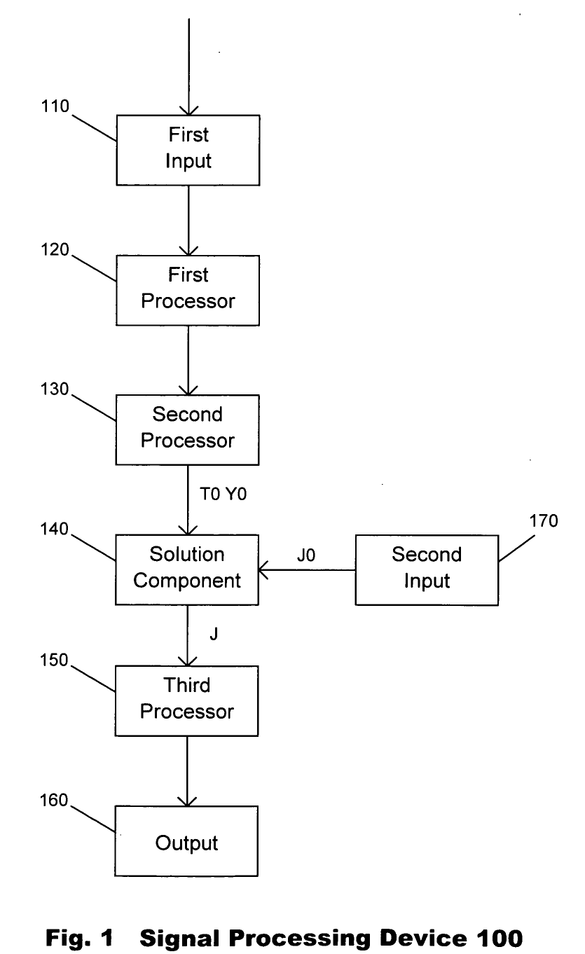

FIG. 1 is a non-limiting example of a signal processing device 100 that comprises a solution component 140 that determines and applies signal weights. A first input 110 is the source for at least one signal that is processed at a first processor 120. A second processor 130 forms a system of equations with a block Toeplitz, or approximately block Toeplitz, coefficient matrix T₀. This system of equations is solved for the solution X by the solution component 140 disclosed in this application. The solution component 140 can processes signals J₀ from a second input 170 with the solution X. The output from the solution component 140 are signals J that are processed by a third processor 150 to form signals for the output 160. Many devices do not have all of these components. Many devices have additional components. Devices can have feedback between components, including feedback from the third processor 150 to the second processor 130, or to the solution component 140. The signals from the second input 170 can be one or more of the signals from the first input 110, or signals from the first processor 120. The solution component 140 can output the solution X as the signals J without processing signals J₀ with the solution X. In this case, the third processor 150 can processes signals J₀ with the signals J, if required. The device 100 can include a communications device, a sensing device, an image device, a general signal processing device, or any device known in the art. The following devices are non-limiting examples of devices that can be represented by the components of device 100.

Sensing devices include active and passive radar, sonar, laser radar, acoustic flow meters, medical, and seismic devices. For these devices, the first input 110 is a sensor or a sensor array. The sensors can be acoustic transducers, optical and electromagnetic sensors. The first processor 120 can include, but is not limited to, a demodulator, decoder, digital filter, down converter, and a sampler. The second processor 130 usually forms the coefficient matrix T₀ from a covariance matrix generated from sampled aperture data from one or more sensor arrays. The aperture data can represent information concerning a physical object, including position, velocity, and the electrical characteristics of the physical object. If the array elements are equally spaced, the covariance matrix can be Hermetian and block Toeplitz. The known vector Y₀ can be a steering vector, a data vector or an arbitrary vector. The solution component 140 solves the system of equations for the signal weights X. The signal weights X can represent weights to be applied to signals J₀ to form signals J that produce a beam pattern. The signals J and signal weights X can also contain information concerning the physical nature of a target. The signal weights can also be included as part of the signals J. The third processor 150 can further process the signals J. The output 160 can be a display device for target information, or a sensor array for a radiated signal.

Communications devices include echo cancellers, equalizers, and devices for channel estimation, carrier frequency correction, speech encoding, mitigating intersymbol interference, and user detection. For these devices, the first input 110 usually includes either hardwire connections, or an antenna array. The first processor 120 can include, but is not limited to, an amplifier, a detector, receiver, demodulator, digital filters, and a sampler. The second processor 130 usually forms the coefficient matrix T₀ from a covariance matrix generated from one of the input signals that usually represents transmitted speech, image or data. The covariance matrix can be symmetric and block Toeplitz. The known vector Y₀ is usually a cross-correlation vector between two transmitted signals also representing speech, image or data. The solution component 140 solves the system of equations for the signal weights X, and combines the signal weights with signals J₀ from the second input 170 to form desired signals J that represent transmitted speech, images and data. The third processor 150 further processes the signals J for the output 160, which can be a hardwire connection, transducer, or display output. The signals from the second input 170 can be the same signals as those from the first input 110.

For devices that control mechanical, chemical, biological and electrical components, the matrix T₀ and the vector Y₀ can be formed by a second processor 130 from signals usually collected by sensors 110 that represent a physical state of a controlled object. These signals are processed by the first processor 120. Usually, sampling the signals are part of this processing. The solution component 140 calculates a weight vector X that can be used to generate control signals J from signals J₀. The signals J₀ are an input from a second input 160. The signals J are usually sent to an actuator or transducer 160 of some type after further processing by a third processor 150. The physical state of the object can also include performance data for a vehicle, medical information, vibration data, flow characteristics of a fluid or gas, measureable quantities of a chemical process, and motion, power, and heat flow, data.

Imaging devices include magnetic resonance imaging (MRI), positron emission tomography (PET), computed tomography (CT), ultrasound devices, synthetic aperture radars, fault inspection systems, sonograms, echocardiograms, and devices for acoustic and geological imaging. The first input component 110 is usually a sensor or a sensor array. The sensors can be acoustic transducers, and optical and electromagnetic sensors. The first processor 120 can include, but is not limited to, a demodulator, decoder, digital filters, down converter, and a sampler. The second processor 130 usually forms the coefficient matrix T₀ from a covariance matrix generated from signals from one or more sensor arrays, or a known function such as a Greene's function. The covariance matrix can be Hermetian and block Toeplitz. The known vector Y₀ can be formed from a measured signal, a data vector, or an arbitrary constant. The solution component 140 solves the system of equations for the unknown vector X. Vector X contains image information that is further processed by the third processor 150 to form an image for display on an image display device 160. The signals J include the vector X as the output of the solution component 140.

As a non-limiting example of an imaging device, a MRI device, can comprise a first input 110 that includes a scanning system with an MRI scanner. The first processor 120 converts RF signals to k-space data. The second processor 130 and the solution component 140 perform image reconstruction by transforming k-space data into image space data by forming and solving a system of equations with a block Toeplitz coefficient matrix. The third processor 150 maps image space data into optical data and transforms optical data into signals for the display 160. The matrix T₀ can be a Fourier operator that maps image space data to k-space data. The vector Y₀ is the measured k-space data. The vector X is image space data.

As a non-limiting example of an imaging device, an ultrasound device, can comprise acoustic receivers 110, a first processor 120 comprising an amplifier, phase detector, and analog-to-digital converters, a second processor 130 can form a coefficient matrix from a Green's function, and a known vector from sensed incident field energy, a solution component 140 that calculates signal coefficients representing the conductivity and dielectric constant of a target object, a third processor 150 comprising a transmit multiplexer, scan devices, oscillator and amplifier, and an output 160 comprising acoustic transmitters, displays, printers and storage.

Many devices include an array antenna system. The device can include an antenna array 110, and a first processor 120 that down-converts, demodulates, and channel-selects signals from the antenna array 110. A second processor 130 calculates steering vectors Y₀, and a covariance matrix T₀ formed from antenna aperture signals. A solution component 140 calculates signal weights X, and multiplies signals J₀ for associated antenna elements by the signal weights X to obtain signals J. A third processor 150 further processes the signals J. The output 160 can be an antenna array, transducer, or display.

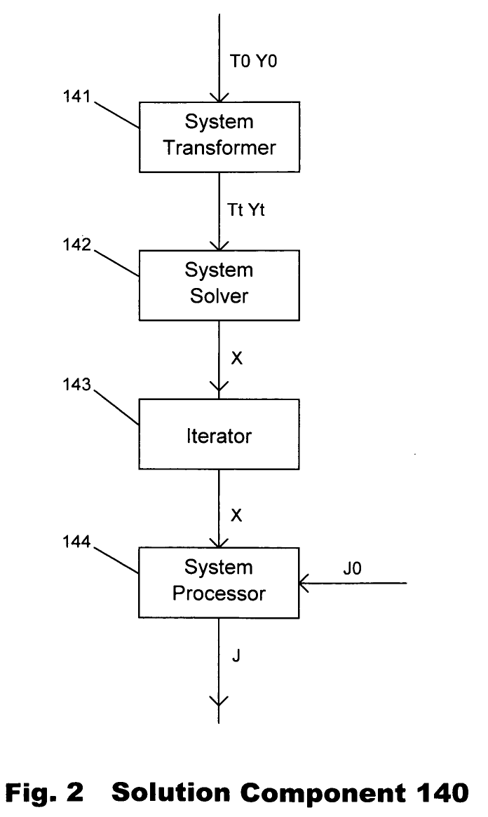

FIG. 2 discloses a solution component 140 that can reduce the dimensions N of a system of equations if the system of equations has a coefficient matrix that has Toeplitz sub-blocks. The vectors in the system of equation are block vectors with each sub-block in a vector corresponding to sub-blocks in the coefficient matrix. New systems of equations are formed with block vectors that are separated into symmetric and asymmetric vectors. The dimensions of the new systems of equations are reduced by eliminating duplicate elements in the vectors.

In an embodiment of the invention, the system transformer 141 separates the sub-vectors of the vectors X₀ and Y₀ into symmetric sub-vectors X_{S}(i) and Y_{S}(i) that have elements i equal to elements N-1-i, and into asymmetric sub-vectors X_{A}(i) and Y_{A}(i), that have elements i equal to the negative of elements N-1-i. The range of i is 0 to N/2−1. The sub-blocks of the block Toeplitz matrix T₀ are separated into skew symmetric Toeplitz sub-blocks T_{A}, and symmetric Toeplitz sub-blocks T_{S}. The original systems of equations can be factored into new systems of equations with symmetric and asymmetric vectors, and coefficient matrices comprising either symmetric or skew symmetric sub-blocks. The following relationships can be used to factor the original system of equations. The product of a symmetric Toeplitz matrix T_{S} and a symmetric vector X_{S} is a symmetric vector Y_{S}. The product of a symmetric matrix T_{S} and a skew symmetric vector X_{A} is a skew symmetric vector Y_{A}. The product of a skew symmetric Toeplitz matrix T_{A} and a symmetric vector X_{S} is a skew symmetric vector Y_{A}. The product of a skew symmetric matrix T_{A} and a skew symmetric vector X_{A} is a symmetric vector Y_{S}.

The system transformer 141 forms a reduced system of equations with vectors from the upper half of vectors X_{S}, X_{A}, Y_{S} and Y_{A}. The sub-blocks of the reduced coefficient matrix are no longer Toeplitz, but instead are the sum or difference of a Hankel and a Toeplitz matrix. Each new sub-block is formed by the system transformer 141, folding each Toeplitz sub-block back on itself, and either adding or subtracting corresponding elements depending on whether the vector X is symmetric or asymmetric.

As a non-limiting example, the system of equations (1) has a real Toeplitz block Toeplitz coefficient matrix T₀. The coefficient matrix T₀ has N_{c} symmetric sub-blocks per row and column. The X₀ and Y₀ vectors have N_{c} sub-vectors. The matrix T₀ has dimensions N×N, and the sub-blocks of T₀ have dimensions N_{b}×N_{b}.

$${T}_{0} {X}_{0} = {Y}_{0} \\ {T}_{0} = \begin{matrix}{T}_{00} & {T}_{01} & {T}_{02} \\ {T}_{01} & {T}_{00} & {T}_{01} \\ {T}_{02} & {T}_{01} & {T}_{00}\end{matrix} \qquad ( 1 )$$

The system transformer 141 separates each sub-vector into symmetric and asymmetric sub-vectors, and forms two systems of equations, one having symmetric vectors X_{S} and Y_{S}, and the other asymmetric vectors X_{A} and Y_{A}. These two real-valued systems of equations have the same coefficient matrix T₀. The sub-vectors of vectors X_{A} and X_{S} have duplicate elements. The dimensions of each of the systems of equations are reduced by folding each of the sub-blocks in half, and either forming a sum or a difference of a Toeplitz matrix, and a Hankel matrix. The lower half of each sub-block is disregarded. This results in two systems of equations with different coefficient matrices T_{A} and T_{S}, having dimensions N/2×N/2. If the coefficient matrix is block Toeplitz, these two systems of equations can be solved by the system solver 142 for the signal coefficients X_{A} and X_{S}.

If the coefficient matrix is Toeplitz block Toeplitz, the system transformer 141 rearranges rows and columns in both coefficient matrices T_{A} and T_{S} to obtain two rearranged block Toeplitz matrices. These rearranged matrices have sub-blocks that are Toeplitz with dimensions N_{c}×N_{c}. The vectors for both of these systems of equations with rearranged coefficient matrices can be split into symmetric block vectors X_{1SS} and X_{1AS}, and skew symmetric block vectors X_{1SA} and X_{1AA} by the system transformer 141. The sub-blocks in both rearranged coefficient matrices can be folded in half by the system transformer 141, with the elements in each sub-block being either the sum or difference of a Toeplitz and a Hankel matrix. Each sub-block now has dimensions N_{c}/2×N_{c}/2. There are now four systems of equations. Each system of equations has a different coefficient matrix, T_{1AA}, T_{1AS}, T_{1SS} and T_{1SA}. The dimensions of each of the four systems of equations are N/4×N/4. The four systems of equations are solved by the system solver 142 using any methods known in the art, for the vectors X_{1SS}, X_{1SA}, X_{1AA} and X_{1AS}.

In a nonlimiting example, the matrix T₀ of equation (1) is a complex Hermetian Toeplitz block Toeplitz matrix. The vectors X₀ and Y₀ are complex vectors. The system of equations can be multiplied out to form a real, and an imaginary, set of equations. These two sets of equations can both be split into sets of equations for symmetric and skew symmetric block vectors. These four sets of equations can be combined into two sets of equations (2) and (3), with the same coefficient matrix having dimensions 2N×2N. The sub-blocks have dimensions N_{b}×N_{b}. There are 2N_{c} sub-blocks in each row and column.

$${TX}_{01} = {Y}_{01} \\ T = \begin{matrix}{T}_{SR} & - {T}_{AI} \\ {T}_{AI} & {T}_{SR}\end{matrix} \\ {Y}_{01} = \begin{matrix}{Y}_{RS} \\ {Y}_{IA}\end{matrix} \\ {X}_{01} = \begin{matrix}{X}_{RS} \\ {X}_{1 A}\end{matrix} \qquad ( 2 )$$

The sub-block T_{SR} is the real symmetric component of the matrix T₀. The sub-block T_{A1} is the imaginary asymmetric component of the matrix T₀.

$${TX}_{02} = {Y}_{02} \\ {Y}_{02} = \begin{matrix}{Y}_{IS} \\ - {Y}_{RA}\end{matrix} \\ {X}_{02} = \begin{matrix}{X}_{IS} \\ - {X}_{RA}\end{matrix} \qquad ( 3 )$$

Each quadrant of the matrix T has Toeplitz sub-blocks. The block vectors X₀₁, X₀₂, Y₀₁ and Y₀₂ contain duplicate elements that can be eliminated by the system transformer 141 folding each matrix T sub-block in half, reducing the dimensions of each sub-block to N_{b}/2×N_{b}/2. If the coefficient matrix T₀ is block Toeplitz, the system solver 142 solves these two systems of equations with the same reduced coefficient matrix T₁ for the vectors X₀₁ and X₀₂.

For a Toeplitz block Toeplitz coefficient matrix T₀, the rows and columns of the reduced coefficient matrix T₁ can be rearranged within each quadrant to form rearranged block vectors X₁₁, X₁₂, Y₁₁ and Y₁₂, and a coefficient matrix T₂. The rearranged block vectors can be split into symmetric block vectors X_{11S}, X_{12S}, Y_{11S} and Y_{12S} and asymmetric block vectors X_{11A}, X_{12A}, Y_{11A} and Y_{12A} with duplicated elements. Each matrix T₂ sub-block can be folded to half dimensions, eliminating the duplicate vector elements. The result is four systems of equations with two different coefficient matrices T_{2S} and T_{2A}, of dimensions N/4×N/₄. The system of equations can each be solved by the system solver 142 for the four block vectors X_{11S}, X_{11A}, X_{12S}, and X_{12A}.

In an embodiment of the disclosed invention, the system transformer 141 of FIG. 2 can add pad rows and columns to, and can modify existing rows and columns of, each Toeplitz sub-block of a coefficient matrix T₀, to form a coefficient matrix T. The coefficient matrix T can be separated into the sum of a symmetric coefficient matrix T_{S} with a purely real Fourier transform, and a skew symmetric coefficient matrix T_{A} with a purely imaginary Fourier transform. The vectors X₀ and Y₀ in the system of equations can each be zero padded, and separated into the sum of two vectors, symmetric vectors X_{S} and Y_{S}, and asymmetric vectors X_{A} and Y_{A}. In each of the symmetric vectors X_{S}(i) and Y_{S}(i), the i th element is equal to the N-i th element. In each of the asymmetric vectors X_{A}(i) and Y_{A}(i), the i th element is the negative of the N-i th element. The range of i is 1 to N/2−1 for this relationship. Index i is also equal to zero and N/2.

The following relationships can be used to factor a system of equations with a block Toeplitz coefficient matrix. The product of a symmetric Toeplitz matrix T_{S}, and a symmetric vector X_{S}, is a symmetric vector Y_{S}. The product of a symmetric matrix T_{S}, and a skew symmetric vector X_{A}, is a skew symmetric vector Y_{A}. The product of a skew symmetric Toeplitz matrix T_{A}, and a symmetric vector X_{S}, is an asymmetric vector Y_{A}. The product of a skew symmetric matrix T_{A}, and a skew symmetric vector X_{A}, is a symmetric vector Y_{S}. The Fourier transform of the symmetric vectors is real. The Fourier transform of the skew symmetric vectors is imaginary.

Generally, the system transformer 141 multiplies out, and separates, a complex system of equations into two systems of equations, one for the real, and the other for the imaginary, terms. Each of these systems of equations are further separated into systems of equations for either symmetric or asymmetric vectors. These four sets of equations are combined to form a real system of equations with dimensions 4N×4N. The vectors in this system of equations are either symmetric or asymmetric. A system of equations is then formed from vectors comprising the upper half of real vector components X_{RS}, X_{RA}, Y_{RS}, Y_{RA}, and the upper half of imaginary vector components X_{IS}, X_{IA}, Y_{IS} and Y_{IA}. A reduced coefficient matrix can be formed that is no longer block Toeplitz. It is a block matrix with sub-blocks that are the sum or difference of a Hankel and a Toeplitz matrix. Each sub-block is formed by folding a portion of a Toeplitz sub-block back on itself, and either adding or subtracting corresponding elements.

In a non-limiting example, the coefficient matrix T₀ is a real Toeplitz block Toeplitz matrix. The system transformer 141 forms two systems of equations (4) and (5) with a real Toeplitz block Toeplitz coefficient matrix T from equation (1). The sub-blocks of matrix T are symmetric with dimensions N_{b}×N_{b}. Coefficient matrix T₀ has dimensions N×N. There are N_{c} sub-blocks in each row and column of T₀. Equation (4) comprises symmetric vectors X_{S} and Y_{S}. Equation (5) comprises skew symmetric vectors X_{A} and Y_{A}. Equations (4) and (5) have the same coefficient matrix T. The sub-vectors of X and Y are all either symmetric or asymmetric.

The system transformer 141 increases the dimensions of each of the sub-blocks in the coefficient matrix of equation (1) by placing pad rows and columns around each of the sub-blocks. The matrix A results from the matrix T having larger dimensions than the matrix T₀, and from modifications made to row and columns of the matrix T₀ to form the matrix T. The vectors S contain unknowns to be determined. The matrix A can comprise elements that improve the solution characteristics of the system of equations, including improving the match between the matrices T and T₀, lowering the condition number of the matrix T, and making a transform of the matrix T, matrix Tₜ, real. Matrix A can comprise modifying columns, and columns with all zero values except for one or two non-zero values corresponding to pad and modified rows of matrix T. Matrix B can comprise pad and modifying rows that modify elements in the T₀ matrix. Vectors X_{S}, X_{A}, Y_{S} and Y_{A} have zero pad elements that correspond to pad rows.

T X_{S}=Y_{S}+A S_{S} (4)

T X_{A}=Y_{A}+A S_{A} (5)

B X_{S}=S_{S}

B X_{A}=S_{A}

Each of the sub-blocks of the coefficient matrix T is separated by the system transformer 141 into a sum of the products of diagonal matrices D₁ᵢ, circulant matrices Cᵢ, and diagonal matrices D₂ᵢ. The elements in the diagonal matrices D₁ᵢ and D₂ᵢ are given by exponential functions with real and/or imaginary arguments, trigonometric functions, elements that are one for either the lower or upper half of the principal diagonal elements, and negative one for the other upper, or lower half, of the principal diagonal elements, elements determined from other elements in the diagonal by recursion relationships, and elements determined by factoring or transforming the matrices containing these elements. For the non-limiting example of a general block Toeplitz matrix, the sub-blocks have the general form of equation (6).

$$T = \begin{matrix}{T}_{00} & {T}_{01} & {T}_{02} \\ {T}_{10} & {T}_{11} & {T}_{12} \\ {T}_{20} & {T}_{21} & {T}_{22}\end{matrix} \qquad ( 6 )$$

The submatrices T_{xy} of equation (6) comprise a product of matrices U_{rixy}, L_{rixy}, and C_{ixy}. The following summation is over the index i.

$${T}_{xy} \sum \frac{{U}_{1 ixy}}{{L}_{1 ixy}} {C}_{ixy} \frac{{U}_{2 ixy}}{{L}_{2 ixy}} \qquad ( 7 )$$

As a non-limiting example, a block coefficient matrix T can be represented by a sum over two products. Each sub-block is separated with the same diagonal matrices d and d*, where the Fourier transform of d is the complex conjugate of the matrix d*. The block matrix T can be separated as follows.

$$\begin{matrix}T = {DC}_{1} {D}^{*} + {D}^{*} {C}_{2} D & ( 8 ) \\ D {C}_{1} {D}^{*} = \vert \begin{matrix}d & & \\ & d & \\ & & d\end{matrix} \vert \vert \begin{matrix}{C}_{100} & {C}_{101} & {C}_{102} \\ {C}_{110} & {C}_{111} & {C}_{112} \\ {C}_{120} & {C}_{121} & {C}_{122}\end{matrix} \vert \vert \begin{matrix}{d}^{*} & & \\ & {d}^{*} & \\ & & {d}^{*}\end{matrix} \vert & ( 9 )\end{matrix}$$

The elements of diagonal matrices d and d* in equation (9) can be approximately expressed as a quotient of a diagonal matrix Uᵣᵢ divided by a diagonal matrix Lᵣᵢ. Each quotient Uᵣᵢ/Lᵣᵢ can be calculated from expression (10), where g(z) is the elements on the principal diagonal of a matrix d. For this example, there are two quotients.

$$g ( z ) ≅ \frac{\sum {A}_{m} cos ( {w}_{m} z ) + \sum {B}_{m} sin ( {w}_{m} z )}{\sum {C}_{m} cos ( {w}_{m} z ) + \sum {D}_{m} sin ( {w}_{m} z )} \qquad ( 10 )$$

Regression methods, including non-linear regression methods, can be used to determine the weight constants for the expansion functions cosine and sine. Regression methods are well known in the art. An iterative, weighted least-squares method can also be used to determine the weight constants of equation (10). The g(z) elements that correspond to pad and modified rows and columns are usually not included in the calculations that determine the weight constants. Once the weight constants have been determined, values for the elements that correspond to pad and modified rows and columns are calculated. These values are then used in place of the original values in the matrices, and determine the pad and modified rows and columns. The modifying rows and columns are calculated from the difference between g(z) and the summation of equation (10). The pad rows and columns are calculated from the matrices Cᵢ and the values from the summation of equation (10). The system transformer 141 alters selected rows and columns of each of the sub-blocks in the coefficient matrix for a better match in equation (10).

A transformed system of equations (11) is formed by transforming each sub-block individually to form a narrow banded sub-block. The matrices T_{L} and T_{R} are block matrices that can comprise Fourier transform (FFT) and inverse Fourier transform (iFFT) sub-blocks that transform a product that comprises each of the sub-blocks T_{xy}. The matrix product Π Lᵣᵢ is a block matrix with sub-blocks that comprise a product of the matrices Lᵣᵢ. The matrices T_{L}, T_{R} and Π Lᵣᵢ usually only have non-zero blocks on the principal diagonal. In a non-limiting example, the matrix Tₜ can be efficiently calculated from equation (12). The matrices Cₜᵢ are block matrices with each sub-block being a diagonal matrix. Each sub-block is the fast Fourier transform of a corresponding sub-block of a matrix Cᵢ. The matrices Cᵢ are determined from equation (8). The matrices Uₜᵣᵢ and Lₜᵣᵢ are block matrices with the only non-zero sub-blocks being the sub-blocks on their principal diagonals. The non-zero sub-blocks of matrix Uₜᵣᵢ are identical. The non-zero sub-blocks of Lₜᵣᵢ are identical. The sub-blocks on the principal diagonals of the matrices Uₜᵣᵢ are narrow banded sub-blocks. The non-zero sub-blocks of the matrices Uₜᵣᵢ and Lₜᵣᵢ are the FFT of the non-zero sub-blocks of the matrices Uᵣᵢ and Lᵣᵢ, respectively. The matrices Uᵣᵢ and Lᵣᵢ have all sub-blocks equal to zero, except for diagonal sub-blocks on their principal diagonals. Matrices Uₜᵣᵢ and Lₜᵣᵢ are usually stored in memory. If all the matrices Lᵣᵢ are equal, the term (Π Lᵣᵢ) is a single matrix L. Only two matrices Uₜᵣᵢ may be required as disclosed in equation (12). The non-zero sub-blocks of the matrices Uₜᵣᵢ comprise corner bands in the upper right and lower left corners of the matrix. These corner bands result in corner bands for the sub-blocks of the matrix Tₜ. The corner bands of the sub-blocks of the matrix Tₜ can be combined with the band around the principal diagonal of the sub-blocks of the matrix Tₜ when the sub-blocks of the matrix Tₜ are folded to reduced dimensions.

Tₜ Xₜ=Yₜ+Aₜ S (11)

Tₜ=T_{L}(Π L₁ᵢ)T(Π L₂ᵢ)T_{R}

Tₜ=Uₜ Cₜ₁ Uₜ*+Uₜ*Cₜ₂ Uₜ (12)

Aₜ=T_{L}(Π L₁ᵢ)A

Yₜ=T_{L}(Π L₁ᵢ)Y

Xₜ=T_{R}(Å inv L₂ᵢ)X

After equations (4) and (5) have been transformed, each transformed sub-block of the two coefficient matrices from equations (4) and (5) can be folded to dimensions (N_{b}/2+1)×(N_{b}/2+1) by the system transformer 141 since the transformed sub-block vectors Xₜ have duplicate elements. The matrix sub-blocks are each either the sum or difference of a Toeplitz and a Hankel sub-block. The result is two real systems of equations with two different coefficient matrices, T_{A} and T_{S}, that have dimensions of N_{c}(N_{b}/2+1)×N_{c}(N_{b}/2+1). If the coefficient matrix T₀ is block Toeplitz, the system solver 142 solves these two systems of equations for the block vectors X_{S} and X_{A}.

If the coefficient matrix T₀ is Toeplitz block Toeplitz, the system transformer 141 rearranges the rows and columns of the coefficient matrices T_{A} and T_{S}. The rows of X_{S}, X_{A}, Y_{S}, Y_{A}, A_{S} and A_{A} are also rearranged. If the rearranged coefficient matrices T_{1S} and T_{1A} are block Toeplitz, the system transformer 141 can increase the dimensions of each of the sub-blocks in the block Toeplitz matrix by placing pad rows and columns around each of the sub-blocks. This increases the number of rows and columns in the rearranged matrices A_{1S} and A_{1A}. The vectors S contain additional unknowns. Matrices A_{1S}, A_{1A}, B_{1S} and B_{1A} further comprise modifying rows and columns that modify elements in the T_{1S} and T_{1A} matrices, and nonzero elements that correspond to pad rows used to increase the dimensions of the matrices T_{1S} and T_{1A}. Vectors X_{1S}, X_{1A}, Y_{1S} and Y_{1A} have zero pad elements added to their rows that correspond to rows that were used to increase the dimensions of the system of equations. The system transformer 141 transforms each sub-block in the rearranged and padded/modified matrices T_{1S} and T_{1A}. The system of equations is transformed with matrices T_{R}, T_{L} and Lᵣᵢ as disclosed in equation (11). Each sub-block is folded, and reduced to dimensions (N_{c}/2+1)×(N_{c}/2+1). Each system of equations produces two new systems of equations, one for symmetric vectors, and the other for skew symmetric vectors. A different single banded, transformed coefficient matrix, T_{2SS}, T_{2SA}, T_{2AS} and T_{2AA}, is formed for each of the four systems of equations that have dimensions (N_{c}/2+1)(N_{b}/2+1)×(N_{c}/2+1)(N_{b}/2+1). The system solver 142 solves the transformed systems equations for each of the four block vectors X_{2SS}, X_{2SA}, X_{2AS} and X_{2AA}.

In a nonlimiting example, the system of equations (1) has a complex Hermetian Toeplitz block Toeplitz coefficient matrix T₀, and complex vectors X₀ and Y₀. The system of equations (1) can be factored into two systems of equations (2) and (3). The matrix T is altered with pad and modified rows and columns to obtain equations (13) and (14).

$$\begin{matrix}{TX}_{01} = {Y}_{01} + {A}_{01} {S}_{01} \\ {A}_{01} = \begin{matrix}{A}_{RS} \\ {A}_{IA}\end{matrix} & ( 13 ) \\ {TX}_{02} = {Y}_{02} + {A}_{02} {S}_{02} \\ {A}_{02} = \begin{matrix}{A}_{IS} \\ - {A}_{RA}\end{matrix} & ( 14 )\end{matrix}$$

The system transformer 141 can pad, separate, and modify each sub-block. Each sub-block can then be transformed to a banded sub-block by matrices T_{R}, T_{L} and Lᵣᵢ as disclosed in equation (11). Each sub-vector is initially either symmetric or asymmetric. The vectors contain duplicate elements that can be eliminated by folding each sub-block. If the coefficient matrix T₀ is block Toeplitz, the two systems of equations can be solved by the system solver 142 after being reduced in dimensions. Both systems of equations have the same coefficient matrix T₀.

The rows and columns within each quadrant can be rearranged within each quadrant to form Toeplitz sub-blocks. The system transformer 141 adds pad or modified rows and columns to each sub-block, and transforms each sub-block to a banded form. Since the transformed sub-blocks are real, the transformed vectors X₁₁, X₁₂, Y₁₁ and Y₁₂ can be split into symmetric and asymmetric components with duplicated elements. The dimensions of each sub-block can then be reduced to eliminate the duplicate elements. The result is four systems of equations with two different coefficient matrices T_{2S} and T_{2A} of dimensions (N_{c}/2+1)(N_{b}/2+1)×(N_{c}/2+1). The system solver 142 solves the transformed systems of equations for each of the four vectors X_{11S}, X_{11A}, X_{12X} and X_{12A}.

The system solver 142 solves the above disclosed systems of equations formed by the system transformer 141 by any methods known in the art. These methods comprise classical methods including Gauss elimination, iterative methods including any of the conjugate gradient methods, and decomposition methods, including eigenvalue, singular value, LDU, QR, and Cholesky decomposition. Each of the solved systems of equations have the form of equation (15). In equation (15), the term X_{y} is the product of an inverse coefficient matrix T, and a vector Y, depending on the embodiment, and the initial system of equations. The coefficient matrix T and vector Y may be a rearranged, or transformed, matrix or vector. The matrix Xₐ is the product of an inverse coefficient matrix T, and matrices Aₚ and A_{q}. The vectors X and S are unknown vectors. The matrix Xₐ may not be required for all embodiments. The matrix B comprises matrices Bₚ and B_{q}, which contain pad rows and modifying rows, respectively. The solution from each of the solved systems of equations is combined to form an approximate solution of equation (1).

X=X_{y}+Xₐ S

S=(I−B Xₐ)⁻¹B X_{y} (15)

For a coefficient matrix with a Toeplitz block Toeplitz structure, the system transformer 141 can form equations using both of the above-indicated disclosed methods. A different embodiment can be used for each level of Toplitzness. The above-indicated disclosed methods can also be applied to asymmetric Toeplitz sub-blocks, and any complex systems of equations. Different devices 100 have different performance requirements with respect to memory storage, memory accesses, and calculation complexity. Depending on the device 100, different portions of the methods can be performed on parallel computer architectures. When the disclosed methods are implemented on specific devices, method parameters such as the matrix Tₜ bandwidth m, number of pad and modified rows p and q, and choice of hardware architecture, must be selected for the specific device.

Further improvements in efficiency can be obtained if the sub-blocks of the coefficient matrix are large, and the inverse of the coefficient matrix T₀, T₀⁻¹, has elements whose magnitude decreases with increasing distance from the principal diagonal of each of the sub-blocks in the matrix T₀⁻¹. The system transformer 141 zero pads the vector X by setting selected rows to zero. The vector X is then divided into a vector X_{yr} and a vector Xᵣ. The vector X_{yr} is first calculated from equation (16), then additional selected row elements at the beginning, and at the end, of each sub-block of the vector X_{yr} are set to zero to form a vector X_{yrp}. The vector Xᵣ is then calculated from equation (17). The matrix Tₛ contains elements of either the matrix T₀, or T that correspond to non-zero elements in the vector Xᵣ. These are usually elements from the corners of the sub-blocks of the matrix T. The non-zero elements in the vector Xᵣ are the additional selected row elements set to zero in the vector X_{yr}. The system transformer 141 transforms equations (16) and (17) for solution by the system solver 142.

T X_{yr}=Y₀ (16)

Tₛ Xᵣ=Y₀−T X_{yrp} (17)

Many Toeplitz block Toeplitz matrices T are ill conditioned. Pad rows and columns can be used to substantially improve the conditioning of the matrix T. If the matrix T is a sufficient approximation to the covariance matrix T₀, the solution X to the system of equations with the matrix T can be used as the solution X₀ to the system of equations with the covariance coefficient matrix T₀. If the solution X is not a sufficient approximation to the solution X₀, the iterator 143 of FIG. 2 uses the solution X to calculate the solution X₀ by any methods known in the art. These methods include obtaining an update to the solution by taking the initial solution X, and using it as the solution to the original matrix equation (18). The difference between the Y₀ vector, and the product of the original T₀ matrix and the solution X, is then used as the new input column vector for the matrix equation (19) with the T matrix. The vectors Yₐ and Xₐ are approximately equal to the vectors Y and X, respectively. The vectors Xₐ and Yₐ are padded vectors.

T₀ X₀=Y₀ (18)

T X=Y₀+A S

T₀ X=Yₐ

T Xᵤ=Y₀−Yₐ+A Sᵤ (19)

X=X+Xᵤ

The column vector Xᵤ is the first update to the vector X. These steps can be repeated until a desired accuracy is obtained. The updates require very few mathematical operations since most quantities have already been calculated for each of the updates.

The system processor 144 calculates signals J from the vector X and the signals J₀ by calculating the sum of products comprising elements of the vector X and the signals J₀. For some devices 100, there are no signals J₀. In these cases, the signals J comprise the vector X. If the vector X and the signals J are both outputs of the solution component 140, the signals J also comprise the vector X. Both the signals J and J₀ can be a plurality of signals, or a single signal.

The choice of hardware architecture depends on the performance, cost and power constraints of the particular device 100 on which the methods are implemented. The vector X_{y}, and the columns of the matrix Xₐ, of equation (15) can be calculated from the vector Yₜ and matrix Aₜ, on a SIMD type parallel computer architecture with the same instruction issued at the same time. The vector Yₜ and the matrix Tₜ can be from any of the above transformed systems of equations. The product of the matrix A and the vector S, and the products necessary to calculate the matrix Tₜ, can all be calculated with existing parallel computer architectures. The decomposition of the matrix Tₜ can also be calculated with existing parallel computer architectures.

The disclosed methods can be efficiently implemented on circuits that are part of computer architectures that include, but are not limited to, a digital signal processor, a general microprocessor, an application specific integrated circuit, a field programmable gate array, and a central processing unit. These computer architectures are part of devices that require the solution of a system of equations with a coefficient matrix for their operation. The present invention may be embodied in the form of computer code implemented in tangible media such has floppy disks, read only memory, compact disks, hard drives or other computer readable storage medium, wherein when the computer program code is loaded into, and executed by, a computer processor, where the computer processor becomes an apparatus for practicing the invention. When implemented on a computer processor, the computer program code segments configure the processor to create specific logic circuits.

The present invention is not intended to be limited to the details shown. Various modifications may be made in the details without departing from the scope of the invention. Other terms with the same or similar meaning to terms used in this disclosure can be used in place of those terms. The number and arrangement of components can be varied.

1. A device comprising digital circuits for processing digital signals, wherein said device is a component in one of an imaging device, a sensing device, a communications device, and a general signal processing device, said device further comprising:
a system transformer for:
separating a coefficient matrix T into a sum of matrix products, said sum of matrix products comprising matrices Cᵢ, wherein said coefficient matrix T is formed from at least one of said digital signals;
calculating a transformed coefficient matrix Tₜ from said matrices Cᵢ; and
calculating a transformed vector Yₜ, wherein said transformed vector Yₜ is calculated from at least one of said digital signals;
a system solver for determining a solution X from said transformed coefficient matrix Tₜ and said transformed vector Yₜ; and
a system processor for calculating signals J from said solution X.

2. A device as recited in claim 1, wherein said coefficient matrix T is block Toeplitz, and said signals J represent at least one of: a beam pattern, physical characteristics of a target, transmitted speech, images and data, information to control a mechanical, electrical, chemical or biological component, an image, frame of speech and data.

3. A device as recited in claim 2, wherein said coefficient matrix T comprises pad rows and columns.

4. A device as recited in claim 2, wherein said coefficient matrix T comprises modified rows and columns.

5. A device as recited in claim 2, wherein said device further comprises an iterator.

6. A device as recited in claim 2, wherein said system transformer calculates matrices Cₜᵢ, wherein said matrices Cₜᵢ are a fast Fourier transform of said matrices Cᵢ.

7. A device as recited in claim 6, wherein said transformed coefficient matrix Tₜ is calculated from said matrices Cₜᵢ.

8. A device as recited in claim 2, wherein said sum of matrix products further comprises diagonal matrices Dᵣᵢ.

9. A method, implemented on a device comprising digital circuits, for determining and applying signal weights to signals J, said signals J representing at least one of: a beam pattern, physical characteristics of a target, transmitted speech, images and data, information to control a mechanical, electrical, chemical, or biological, component, an image, frames of speech and data, said method comprising the steps of:
forming a coefficient matrix T from input signals;
separating said coefficient matrix T into a sum of matrix products, said sum of matrix products comprising matrices Cᵢ;
calculating a transformed coefficient matrix Tₜ from said matrices Cᵢ;
calculating a transformed vector Yₜ from said input signals;
calculating a solution vector X from said transformed coefficient matrix Tₜ and said transformed vector Yₜ; and
calculating said signals J from said solution X.

10. A method as recited in claim 9, wherein said coefficient matrix T is block Toeplitz, and said device comprising digital circuits is a component in one of an imaging device, a sensing device, a communications device, and a general signal processing device,

11. A method as recited in claim 10, wherein said coefficient matrix T comprises pad rows and columns.

12. A method as recited in claim 10, wherein said coefficient matrix T comprises modified rows and columns.

13. A method as recited in claim 10, said method further comprises calculating iterative updates for said solution vector X.

14. A method as recited in claim 10, said method further comprises calculating matrices Cₜᵢ, from a fast Fourier transform matrix and said matrices Cᵢ.

15. A method as recited in claim 14, said method further comprises calculating said transformed coefficient matrix Tₜ from said matrices Cₜᵢ.

16. A device as recited in claim 10, wherein said sum of matrix products further comprises diagonal matrices Dᵣᵢ.

17. A device comprising digital circuits for processing digital signals, wherein said device is a component in one of an imaging device, a sensing device, a communications device, and a general signal processing device, said device further comprising:
a system transformer for reducing dimensions of an initial system of equations with a block Toeplitz coefficient matrix T₀ and a vector Y₀, wherein said coefficient matrix T₀ and said vector Y₀ are formed from input signals;
a system solver for calculating a solution vector X from said coefficient matrix T₀ and said vector Y₀; and
a system processor for calculating signals J from said solution vector X, wherein said signals J represent at least one of: a beam pattern, physical characteristics of a target, transmitted speech, transmitted images, transmitted data, information to control a mechanical, electrical, chemical, or biological, component, an image, speech and data.

18. A device as recited in claim 17, wherein said system transformer separates said vector Y₀ into symmetric vectors Y_{S} and asymmetric vectors Y_{A}, and separates said coefficient matrix T₀ into a symmetric matrix T_{S} and a skew symmetric matrix T_{A}.

19. A device as recited in claim 18, wherein said system transformer:
forms systems of equations comprising vectors Y, wherein said vectors Y include said symmetric vectors Y_{S} and said asymmetric vectors Y_{A}; and
reduces dimensions of a coefficient matrix T, said coefficient matrix T formed from said symmetric matrix T_{S} and said skew symmetric matrix T_{A}, by eliminating duplicate elements in said symmetric vectors Y_{S} and said asymmetric vectors Y_{A}.

20. A device as recited in claim 19, wherein said solution vector X is calculated from a solution to more than one system of equations.
